(19) United States
(12) Patent Application Publication
(10) Pub. No.: US 2017/0236520 A1
(43) Pub. Date: Aug. 17, 2017

(54) Generating Models for Text-Dependent Speaker Verification

(71) Applicant: KnuEdge Incorporated, San Diego, CA (US)

(72) Inventors: Bengt Jonas Borgstrom, La Jolla, CA (US); Derrick Raymond Roos, San Diego, CA (US)

(21) Appl. No.: 15/045,014

(22) Filed: Feb. 16, 2016

(51) Int. Cl. G10L 17/24; G10L 17/18; G10L 17/02; G10L 17/04; G10L 17/12

(52) U.S. Cl. CPC G10L 17/24; G10L 17/04; G10L 17/12; G10L 17/02; G10L 17/18

(57) ABSTRACT

In one aspect, a method includes receiving a prompt for use with text-dependent speaker verification; generating a linguistic representation of the prompt, wherein the linguistic representation comprises a sequence of speech units; obtaining a plurality of feature vectors or a plurality of acoustic models; generating a universal background model for the prompt using the plurality of feature vectors or the plurality of acoustic models; receiving audio enrollment data of a first speaker speaking the prompt; and creating a first speaker verification model for the first speaker by adapting the universal background model using the audio enrollment data.

### BACKGROUND

Speaker verification may be used to authenticate the identity of a user who claims to be a particular user. For example, speaker verification may be used to sign in to a computer. The user signing in to the computer (“actual user”) may assert that they are a particular user (“claimed user”), for example, by typing in a user name. The actual user may then speak a prompt. To determine whether the actual user is the claimed user, the voice of the actual user may be compared to a previously created mathematical model that describes the voice of the claimed user.

A speaker verification system may be text dependent in that the user being authenticated must speak a specific prompt or a prompt from among a group of known prompts. The prompt may be specific to the user or may be the same as prompts used by other people. For example, suppose that the prompt is “knock knock who's there.” A speaker verification model may be created for a user that describes how that user speaks the prompt, and the model may be created from several audio recordings of the user speaking that same prompt. Later, when the actual user is authenticating to the computer, the actual user will then speak that same prompt and the recorded audio will be compared against the mathematical model of the claimed user speaking that prompt to determine if the actual user is the claimed user.

It may be desired to customize the prompt that is used for text-dependent speaker verification. For example, it may be desired to use the prompt “open sesame” instead of “knock knock who's there.”

### SUMMARY

This disclosure relates to systems and techniques for efficiently creating text-dependent speaker verification models for different prompts—i.e., essentially any arbitrary prompt desired by the user. The subject matter described here may be implemented as a system, a method, non-transitory computer-readable media, or a combination thereof.

In an exemplary implementation, speaker verification models may be created by receiving a prompt for use with a text-dependent speaker verification system; generating a linguistic representation of the prompt, wherein the linguistic representation includes a sequence of speech units; obtaining, from a data store of feature vectors, a plurality of feature vectors for each speech unit in the plurality of speech units; generating a universal background model for the prompt using the plurality of feature vectors for each speech unit in the plurality of speech units; receiving audio enrollment data of a first user speaking the prompt; and creating a first speaker verification model for the prompt and the first user by adapting the universal background model for the prompt using the audio enrollment data.

Creating a speaker verification model may further involve receiving audio data for speaker verification processing, wherein the audio data represents speech of a user; processing the audio data with the first speaker verification model to generate a first score; processing the audio data with the universal background model to generate a second score; and determining that the user is the first user using the first score and the second score. The audio data may have feature vectors extracted from an audio signal.

Creating a speaker verification model may further involve generating cohort models for the prompt, wherein each cohort model is generated by obtaining audio data for a respective cohort; and adapting the universal background model using the audio data for the respective cohort.

Further, the process may involve receiving audio data for speaker verification processing, wherein the audio data represents speech of a user; processing the audio data with the first speaker verification model to generate a first score; processing the audio data with the plurality of cohort models to generate a plurality of scores; and determining that the user is the first user using the first score and the plurality of scores. Determining that the user is the first user using the first score and the plurality of scores may involve generating a normalized first score using the first score and the plurality of scores; and comparing the normalized first score to a threshold.

Generating the normalized first score may involve calculating a mean of the plurality of scores; calculating a standard deviation of the plurality of scores; subtracting the first score by the mean; and dividing a result of the subtracting by the standard deviation. Further, generating the normalized first score comprises using a Z-norming procedure, a T-norming procedure, a ZT-norming procedure, or an S-norming procedure.

The speech units involved may be phonemes, phonemes in context, portions of phonemes, combinations of phonemes, triphones, syllables, portions of syllables, or combinations of syllables.

Adapting the universal background model may involve performing maximum a posteriori adaptation or maximum likelihood linear regression adaptation.

Generating the universal background model for the prompt using the plurality of feature vectors for each speech unit in the plurality of speech units may involve generating a Gaussian mixture model for the universal background model using the expectation-maximization algorithm.

Generating the universal background model for the prompt using the plurality of feature vectors for each speech unit in the plurality of speech units may involve weighting a first feature vector corresponding to a first speech unit, wherein a weight of the first feature vector is determined using at least one of (i) an expected duration of the first speech unit, (ii) a number of occurrences of the first speech unit in the prompt, or (iii) a number of feature vectors corresponding to the first speech unit.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIGS. 1A and 1B are block diagrams showing examples of a text-dependent speaker verification system.

FIGS. 2A, 2B, and 2C are block diagrams showing examples of creating speaker verification models for a specified prompt.

FIG. 3 is a flowchart showing an example of a process for generating models for speaker verification for a specified prompt.

FIG. 4 is a flowchart showing an example of a process for performing speaker verification for a specified prompt.

FIG. 5 is an exemplary computing device that may be used to generate speaker verification models and/or perform speaker verification.

### DETAILED DESCRIPTION

A universal background model (UBM) may be used to modify an existing text-dependent speaker verification system to use a new prompt. For example, a text-dependent speaker verification system may be created for the prompt “knock knock who's there” and this speaker verification system may be provided with speaker verification models created specifically for that prompt. A user of the speaker verification system may desire to use a different prompt, such as “open sesame,” but speaker verification models may not yet exist for that prompt. A UBM may be used to create speaker verification models for this new prompt.

Generally speaking, a UBM describes general features of speech of a large group of people, such as people who speak English, female speakers, or speakers of a certain age group. A universal background model may be compared with a speaker verification model for a specific user, which may describe features of speech of a specific user. In a speaker verification system, a user provides an audio sample of speaking a specific prompt. The audio sample may be compared with a UBM for the prompt to generate a first score. The audio sample may also be compared to a speaker verification model for a first user speaking the prompt to generate a second score. Using the first and second score, a determination may be made as to whether the user is the first user. For example, the determination may be based on a likelihood ratio test.

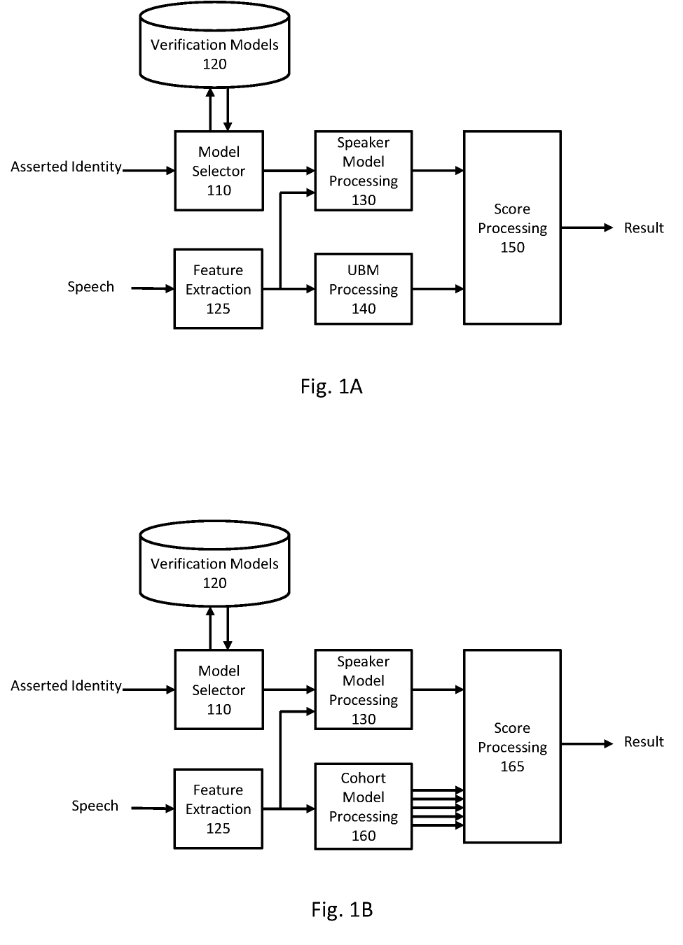

FIG. 1A is a block diagram showing an illustrative implementation of a speaker verification system using a UBM. As an example, the following will illustrate a user using speaker verification to unlock a computer, such as a smartphone. The user desiring to gain access may assert his or her identity, e.g., by providing a user name or an identification number. The user also speaks a prompt that is captured by a microphone to generate an audio signal. The audio signal may be processed by the speaker verification system to determine if the speech corresponds to the asserted identity.

A model selector component 110 may retrieve a speaker verification model from a verification models database 120 corresponding to the asserted identity. The verification models database 120 may contain a speaker verification model for the prompt for each user who needs to gain access. The speaker verification model may be any model used for speaker verification, such as a Gaussian mixture model. The verification models database 120 may index the speaker verification models so that model selector 110 can retrieve a model by providing the identity provided by the user.

A feature extraction component 125 may extract feature vectors from the audio signal. The extracted feature vectors may include any features that are used for speaker verification, such as mel-frequency coefficients, perceptual linear prediction features, or neural network features. For example, feature extraction component 125 may create a sequence of feature vectors for every 10 milliseconds of the audio signal. These feature vectors are processed by both speaker model processing component 130 and UBM processing component 140.

Speaker model processing component 130 receives the selected speaker verification model from model selector component 110 and the feature vectors from feature extraction component 125. Speaker model processing component 130 compares the feature vectors to the selected speaker verification model to determine a first score indicating a match or similarity between the two. The first score may include, for example, a likelihood, a posterior probability, or a confidence interval.

In some implementations, the speaker verification model may comprise a Gaussian Mixture Model (GMM). To compute the score for the speech being processed, a preliminary score may be created for each feature vector by comparing the feature vector to the GMM. The preliminary scores for the feature vectors may then be combined to compute the score for the speech being processed. A score for a single feature vector may be computed, for example, be selecting a Gaussian from the GMM that is closest to the feature vector (e.g., using a distance measure), and then computing a probability that the feature vector was produced by that closest Gaussian. The scores for the feature vectors may be combined using any appropriate techniques, such as determining a product of the scores or summing logarithms of the scores.

UBM processing component 140 receives the features from feature extraction component 125 and compares the features to a UBM for the prompt to determine a second score indicating a match or similarity between the two. The second score may include, for example, a likelihood, a posterior probability, or a confidence interval. The score for the UBM may be determined in a similar manner as the score for the speaker verification model.

Score processing component 150 receives the first score from speaker model processing component 130 and the second score from UBM processing component 140 and processes the scores to determine whether the speech of the user matches the speaker verification model for the asserted identity. For example, speech processing component 150 may compute a likelihood ratio and compare the ratio to a threshold to make the determination.

In some implementations, any of the foregoing components may be combined into a single component. For example, speaker model processing component 130, UBM processing component 140, and score processing component 150 may be implemented as a single component.

FIG. 1B is a block diagram showing an illustrative implementation of a speaker verification system using cohort models. A cohort model describes features of speech of a group of people that is more specific than a UBM. The number and type of cohorts may depend on a particular implementation. For example, in some implementations, a cohort model may be created for 10-year age groups for each gender, such as the following: males aged 0-10 years, females aged 0-10 years, males aged 11-20 years, females aged 11-20 years, and so forth. In some implementations, cohort models may be created using speech data that has been automatically clustered. For example, a corpus of speech data may be available for a large number of speakers. Clustering techniques, such as k-means, may be used to group speakers into a number of clusters based on similarities in the voices of the speakers. After the corpus of speech data has been grouped into clusters, a cohort model may be created from the speech data in each cluster. In some implementations, cohort models may be created by adapting a UBM as described in greater detail below.

In FIG. 1B, model selector component 110, verification models database 120, feature extraction component 125, and speaker model processing component 130 may have any of the features for those corresponding components in FIG. 1A.

In FIG. 1B, cohort model processing component 160 may receive the features from feature extraction component 125 and produce a score for each cohort model of a plurality of cohort models. The score may indicate a match or similarity of the features with the respective cohort model. Any suitable cohort models may be used, and cohort model processing component 160 is not limited to the above examples of cohort models. The score may include, for example, a likelihood, a posterior probability, or a confidence interval. Cohort model processing component 160 may accordingly produce a plurality of scores for the plurality of cohort models. The score for each cohort model may be determined in a similar manner as the score for the speaker verification model.

Score processing component 165 receives the first score from speaker model processing component 130 and the plurality of scores from cohort model processing component 160 and processes the scores to determine whether the speech of the user matches the speaker verification model for the asserted identity. For example, speech processing component 165 may use hypothesis testing techniques to make the determination.

In some implementations, score processing component 165 may compute a normalized score and then compare the normalized score to a threshold to determine whether the speech of the user matches the speaker verification model for the asserted identity. Normalizing the scores may decrease the effects of noise and/or artifacts due to environmental or device characteristics. A normalized score may be generated using the plurality of scores from the cohort models. A mean and standard deviation may be computed from the plurality of scores for the cohort models. A normalized score may be generated by subtracting the mean from the first score and then dividing by the standard deviation. This normalized score may then be compared to a threshold. In some implementations, other normalization procedures may be used such as a Z-norming procedure, a T-norming procedure, a ZT-norming procedure, or an S-norming procedure.

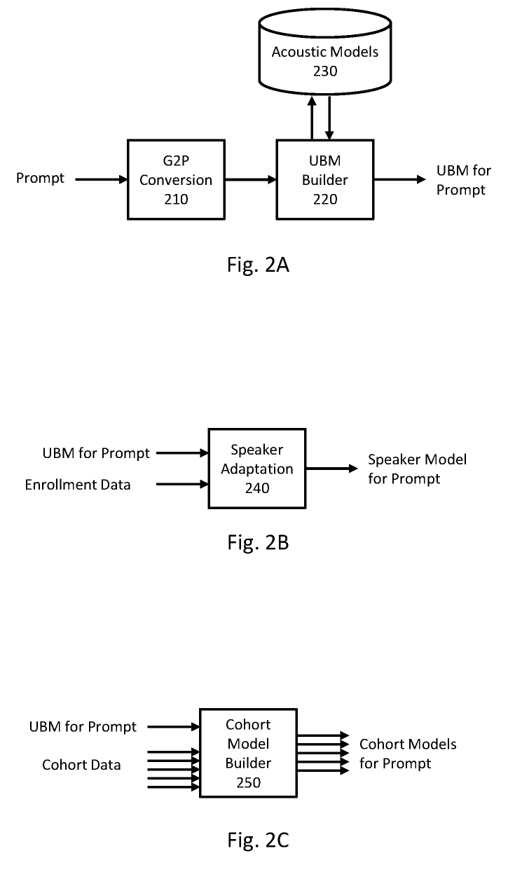

FIGS. 1A and 1B provide examples of how a speaker verification system may use a UBM and/or cohort models to verify the identity of a speaker. The examples of FIGS. 1A and 1B used an existing prompt and existing models for the prompt (UBM, cohort models, and speaker verification models). The following description provides example implementations of receiving a new prompt and creating models for the new prompt. In particular, FIG. 2A provides an example implementation of creating a UBM for a new prompt, FIG. 2B, provides an example implementation of creating a speaker verification model for a new prompt, and FIG. 2C provides an example implementation of creating cohort models for a new prompt.

FIG. 2A is a block diagram showing an illustrative implementation of creating a UBM for a provided prompt. A prompt is provided to be used with a speaker verification system. For example, the prompt may be provided by a company to be used with a speaker verification system for the company or a user may provide a prompt that the user would like to use with a speaker verification system. The prompt may include one or more words to be spoken by a user when seeking to authenticate with a speaker verification system.

In FIG. 2A, grapheme-to-phoneme (G2P) conversion component 210 receives the prompt and outputs a linguistic representation of the prompt. Any suitable G2P conversion technique and any suitable linguistic representation may be used and the techniques described herein are not limited to any particular G2P conversion technique or linguistic representation.

A linguistic representation is any representation of sounds corresponding to the words of the prompt. A linguistic representation may be a sequence of speech units, where each speech units indicates the sound of a portion of the prompt. In some implementations, the speech units may comprise a sequence of phonemes, groups of phonemes, or portions of phonemes. For example, the speech units may comprise phonemes in context, triphones, or diphones. In some implementations, the speech units may comprise a sequence of syllables, groups of syllables, or portions of syllables. Any appropriate speech units may be used for the linguistic representation.

A G2P conversion technique may receive the prompt and produce the speech units of the linguistic representation. In some implementations, a G2P conversion technique may use a dictionary or lexicon of pronunciations to produce the linguistic representation. For example, a previously-generated dictionary or lexicon may include pronunciations for words of a language by providing a sequence of speech units for each word of the language. The previously generated pronunciations may have been created manually or automatically. In some implementations, a G2P conversion technique may generate the linguistic representation automatically, such as using previously trained n-grams and/or decision trees.

UBM builder component 220 receives the linguistic representation of the prompt from G2P conversion component 210 and produces a UBM for the prompt using acoustic models from acoustic models data store 230. The acoustic models in acoustic models data store 230 may have been previously created or may have been specifically created for generating models for a speaker verification system. Any type of acoustic model may be used, including but not limited to Gaussian mixture models (GMMs), hidden Markov models (HMMs), and neural network models.

In some implementations, the UBM produced by UBM builder component 220 may be a GMM created from GMMs for the speech units in the linguistic representation. For example, suppose the linguistic representation comprises a sequence of four speech units denoted as A, B, C, and D. UBM builder component 220 may retrieve, from the acoustic models data store, a GMM for speech unit A, a GMM for speech unit B, a GMM for speech unit C, and a GMM for speech unit D. UBM builder component 220 may then combine the four GMMs to create the UBM.

Any appropriate GMMs may be used for the acoustic models data store 230 and the UBM. For example, each Gaussian in a GMM may comprise one or more of a mean, a covariance matrix, and a weight. The covariance matrix may be, for example, a diagonal covariance matrix or a full covariance matrix.

In some implementations, the GMM for the UBM may comprise all of the Gaussians for each speech unit in the linguistic representation. For example, if the GMM for speech unit A has 12 Gaussians, the GMM for speech unit B has 15 Gaussians, the GMM for speech unit C has 11 Gaussians, and the GMM for speech unit D has 13 Gaussians, then the GMM for the UBM may comprise 51 (12+15+11+13) Gaussians. In some implementations, the weights of the Gaussians of the UBM may be normalized. For example, they may be normalized to sum to 1.

In some implementations, the GMM for the UBM may be pruned. It may be desired to limit the total number of Gaussians in the GMM for the UBM to a maximum number. The Gaussians may be pruned from the GMM using any appropriate techniques. For example, Gaussians with the smallest weight may be pruned, or pairs of Gaussians with the greatest similarity (e.g., as determined by a Bhattacharyya distance or a Mahalanobis distance) may be identified and those pairs may be merged.

In some implementations, other information may be used in producing the UBM. For example, some speech units may generally be short in time (e.g., a stop consonant) and other speech units may generally be long in time (e.g., vowels). Typical or expected durations may be obtained for each speech unit. For example, a large amount of recorded speech may be obtained, and the duration of each speech unit in the recorded speech may be obtained. The expected duration of a speech unit may be determined as a statistic of the measured durations of all examples of that speech unit, such as a mean or a median of the measured durations. When combining the GMMs of each speech unit to produce the GMM for the UBM, the expected durations may be used. For example, the weights of the Gaussians in the GMM of a single speech unit may be weighted according to the duration of the speech unit. Accordingly, longer duration speech units will have higher weights and shorter duration speech units will have lower weights.

In some implementations, the number of occurrences of a speech unit in the linguistic representation of the prompt may be used in producing the GMM for the UBM. For example, suppose the linguistic representation comprises the sequence of speech units A, B, A, and C. When combining the GMMs of the speech units to produce the GMM of the UBM, only one instance of the GMM of speech unit A may be used, but the weights of the GMM of speech unit A may be doubled to account for the two appearances of speech unit A in the linguistic representation. More generally, the weights of the GMMs may be multiplied by the number of occurrences of the corresponding speech unit in the prompt.

In some implementations, the UBM produced by UBM builder component 220 may comprise a HMM. Each state of the HMM may correspond to another model, such as a GMM. The HMM may be created by combining HMMs from acoustic models in the acoustic models data store 230. As above, suppose the linguistic representation comprises a sequence of four speech units denoted as A, B, C, and D. UBM builder component 220 may retrieve, from the acoustic models data store, an HMM for speech unit A, an HMM for speech unit B, an HMM for speech unit C, and an HMM for speech unit D. UBM builder component 220 may then combine the four HMMs to create the UBM.

An HMM may comprise a sequence of states with allowed transition paths between the states. For example, an HMM may comprise a sequence of three states with allowed transitions from each state to the next state and from each state to itself. Each transition may be associated with a probability.

UBM builder component 220 may create an HMM for the UBM by concatenating the HMMs for each speech unit in the linguistic representation. A transition may be added from the last state of the HMM of the first speech to the first state of the HMM of the second speech unit. The HMMs for subsequent speech units may be concatenated in a similar fashion.

In some implementations, UBM builder component 220 may create a UBM for the prompt using stored feature vectors instead of stored acoustic models. Acoustic models data store 230 may be replaced by a feature vector data store (not shown) where feature vectors may be stored, and the feature vectors may be associated with speech units. The feature vectors may be obtained and associated with speech units using any suitable techniques. For example, where a transcribed corpus of speech is available, feature vectors obtained from the corpus may be associated with speech units (e.g., obtained from the transcription) using a forced alignment technique. The feature vector data store may accordingly store a plurality of feature vectors for each speech unit in a language.

UBM builder component 220 may create a UBM for the prompt using the stored feature vectors. If the linguistic representation comprises the speech units A, B, C, and D, feature vectors corresponding to these speech units may be retrieved from the feature vector data store, and these feature vectors may be used to build a UBM. For example, a GMM for the UBM may be created using the expectation-maximization algorithm and the features for each of the speech units.

In some implementations, the feature vectors may be weighted when using them to build a UBM. The weighting may be based on any of the techniques discussed above (e.g., speech unit duration and/or number of occurrences of the speech unit in the prompt), and also the number of feature vectors for a speech unit in the data store (or a number of feature vectors for a speech unit that are used to build the GMM). The weight may be the inverse of the number of feature vectors for the speech unit in the data store (or the number used to build the UBM). For example, suppose that the data store has N₁ feature vectors for speech unit A, N₂ feature vectors for speech unit B, N₃ feature vectors for speech unit C, and N₄ feature vectors for speech unit D. The feature vectors for speech unit A may be assigned a weight of 1/N₁, the feature vectors for speech unit B may be assigned a weight of 1/N₂, the feature vectors for speech unit C may be assigned a weight of 1/N₃, and the feature vectors for speech unit D may be assigned a weight of 1/N₄. This weight may be combined with any of the other weights discussed above.

FIG. 2B is a block diagram showing an illustrative implementation of creating a speaker verification model for a provided prompt using the UBM for the prompt. Speaker adaptation component 240 receives a UBM for the prompt and enrollment data of a speaker. The UBM for the prompt may be created using any appropriate techniques, such as the techniques illustrated in FIG. 2A.

The enrollment data comprises speech of the user for whom the speaker verification model is being created. The enrollment data may be an audio signal of recorded speech or processed recorded audio (e.g. feature vectors computed from an audio signal or acoustic models created from recorded audio). In some implementations, the enrollment data may comprise one or more examples of the user speaking the prompt. In some implementations, the enrollment data may comprise other speech and may not comprise speech of the user speaking the prompt.

Speaker adaptation component 240 may produce a speaker verification model for the prompt and the user by performing adaptation techniques on the UBM. Any appropriate adaptation techniques may be used, including but not limited to maximum a posteriori (MAP) adaptation, maximum likelihood linear regression (MLLR) adaptation, or speaker space methods. The speaker verification model may be any type of acoustic model, including any of the acoustic model types described above for the UBM.

FIG. 2C is a block diagram showing an illustrative implementation of creating cohort models for a provided prompt using the UBM for the prompt. Cohort model builder component 250 receives a UBM for the prompt and cohort data. The UBM for the prompt may be created using any appropriate techniques, such as the techniques illustrated in FIG. 2A.

The cohort data comprises speech of cohorts for whom the cohort models are being created. The cohort data may be audio signals of recorded speech or processed recorded audio (e.g. feature vectors computed from an audio signal or acoustic models created from recorded audio) corresponding to different cohorts. For example, if there are 10 cohorts, there may be a group of audio signals for each cohort or a total of 10 groups of audio signals. In some implementations, the cohort data may comprise examples of people speaking the prompt. In some implementations, the cohort data may comprise other speech and may not comprise speech of people speaking the prompt.

Cohort model builder component 250 may produce cohort models for the prompt by performing adaptation techniques on the UBM. Any appropriate adaptation techniques may be used, including but not limited to maximum a posteriori (MAP) adaptation, maximum likelihood linear regression (MLLR) adaptation, or speaker space methods. The cohort models may be any type of acoustic model, including any of the acoustic model types described above for the UBM.

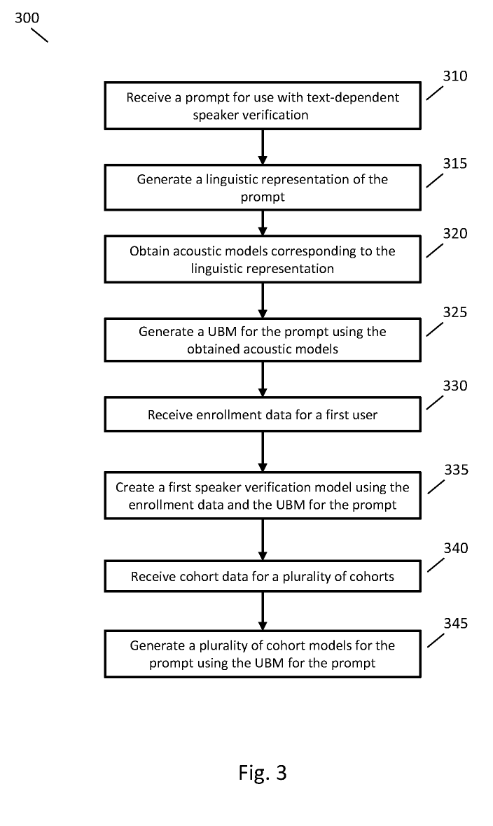

FIG. 3 is a flowchart illustrating an example implementation of a process 300 for generating models for speaker verification for a specified prompt. In FIG. 3, the ordering of the steps is exemplary and other orders are possible, not all steps are required and, in some implementations, some steps may be omitted or other steps may be added. The process may be implemented, for example, by one or more computers, such as the computers described herein.

At step 310, a prompt is received for use with a text-dependent speaker verification system. For example, the prompt may be provided by an individual user for his or her own use or may be specified by company for use by its employees. The prompt may comprise one or more words and the words may be words found in a dictionary or may be made up words.

At step 315, a linguistic representation of the prompt is generated. The linguistic representation may comprise a sequence of speech units, and any suitable speech units may be used, such as phonemes or triphones. Any appropriate techniques may be used to generate the linguistic representation of the prompt.

At step 320, acoustic models corresponding to the linguistic representation are obtained. For example, for each speech unit in the linguistic representation, an acoustic model for the speech unit may be retrieved from a database. Any appropriate acoustic models may be used, such as GMMs, HMMs, and/or neural networks. In some implementations, feature vectors may be obtained instead of acoustic models for each speech unit, as described above.

At step 325, a UBM is generated for the prompt using the acoustic models (or feature vectors) obtained at step 320. Any appropriate techniques may be used to combine the acoustic models to create the UBM, such as any of the techniques described above. For examples, where the acoustic models comprise GMMs, the GMMs for the speech units may be combined to create a GMM for the UBM.

At step 330, enrollment data is received for a first user. The enrollment data may be any data suitable for adapting a model. For example, the enrollment data may comprise audio of the first user speaking the prompt, audio of the first user speaking other words, processed audio (e.g., feature vectors) of speech of the first user, or acoustic models that have been previously adapted for the first user.

At step 335, a speaker verification model is created for the first user using the enrollment data for the first user and the UBM for the prompt. For example, the UBM for the prompt may be adapted using the enrollment data and using any suitable adaptation algorithm, such as MAP adaptation or MLLR adaptation. Steps 330 and 335 may be repeated for any number of speakers. For example, if is desired to create speaker verification models for a group of people (e.g., employees of a company), steps 330 and 335 may be repeated for each user in the group.

At step 340, a cohort data is received for a plurality of cohorts. Any suitable cohorts may be used, such as specified cohorts (e.g., based on age and gender) or automatically generated cohorts (e.g., based on clustering techniques). The cohort data for a cohort may be any of the same types of data for the enrollment data except that the data corresponds to the group of people in the cohort as opposed to a single individual.

At step 345, a plurality of cohort models for the prompt are generated using the cohort data and the UBM for the prompt. Each cohort model may be generated by adapting the UBM for the prompt using the cohort data for the respective cohort. Any suitable adaptation algorithm may be used, such as MAP adaptation or MLLR adaptation.

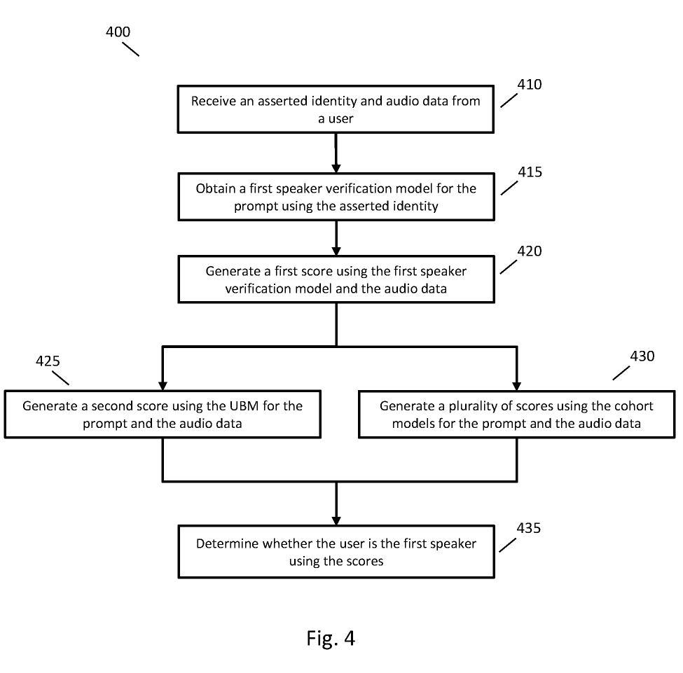

FIG. 4 is a flowchart illustrating an example implementation of a process for performing speaker verification for a specified prompt. In FIG. 4, the ordering of the steps is exemplary and other orders are possible, not all steps are required and, in some implementations, some steps may be omitted or other steps may be added. The process may be implemented, for example, by one or more computers, such as the computers described herein.

At step 410, an asserted identity and audio data is received from a user. The asserted identity and audio data may be received under any circumstances where speaker verification is suitable for authentication. For example, a user may be gaining access to a device (e.g., a smart phone or personal computer) and the user may type in an identification code (e.g., a user name or identification number) and speak the prompt into a microphone of a device. In another example, a user may be gaining access to a room and enter an identification code on a terminal (e.g., a key pad) and speak into a microphone on the terminal. The user may assert an identity in any suitable way. For example, instead of entering an identification code, the user may speak his or her name or provide another biometric, such as a photograph, fingerprint, or iris scan. The received audio data may be in any suitable format, such as an audio signal of recorded speech or features computed from an audio signal.

At step 415, a first speaker verification model is obtained using the asserted identity, where the first speaker verification model corresponds to a first user. For example, the asserted identity may be used to retrieve the first speaker verification model from a database where the first speaker verification model is associated with the asserted identity. For example, the first speaker verification model may have been previously created for a first user using process 300.

At step 420, a first score is generated using the retrieved model and the audio data. The first score may be generated using any suitable techniques for scoring audio data against a speaker verification model, such as the techniques described above.

Depending on the implementation, the next step may correspond to one or both of step 425 and step 430. In some implementations, only step 425 will be performed, in some implementations only step 430 will be performed, and in some implementations, both steps 425 and 430 will be performed.

At step 425, a second score is generated using the UBM for the prompt and the audio data. The second score may be generated using any suitable techniques for scoring audio data against a UBM, such as the techniques described above.

At step 430, a plurality of scores is generated using the plurality of cohort models for the prompt and the audio data. The plurality of scores may be generated using any suitable techniques for scoring audio data against cohort models, such as the techniques described above.

At step 435, a determination is made as to whether the user who provided the asserted identity and the audio data is the first user. This determination may be made using the first score and one or both of the second score or the plurality of scores. In some implementations, the user may be determined to be the first user if the first score is greater than the second score (with appropriate weightings or normalization). In some implementations, the user may be determined to be the first user if a normalized first score exceeds a threshold, where the normalized first score is created by normalizing the first score with the plurality of scores.

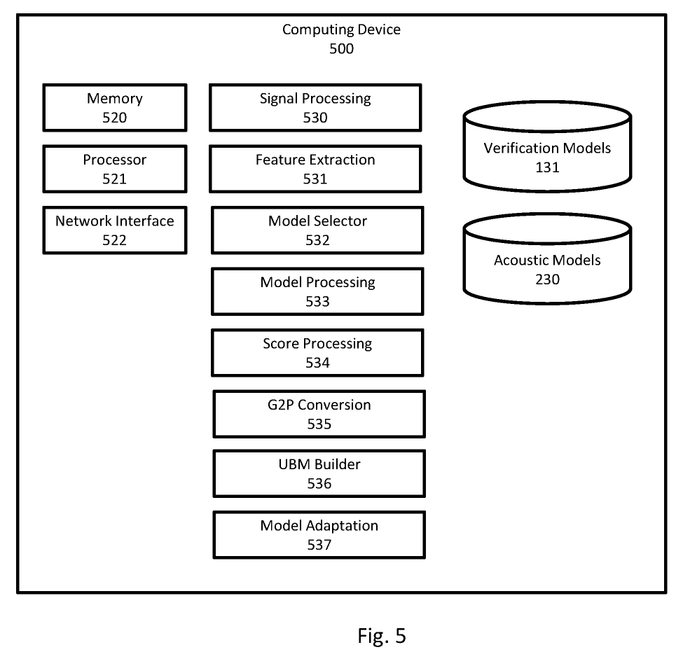

FIG. 5 illustrates components of one implementation of a computing device 500 for implementing any of the techniques described above. In FIG. 5, the components are shown as being on a single computing device 500, but the components may be distributed among multiple computing devices, such as a system of computing devices, including, for example, an end-user computing device (e.g., a smart phone or a tablet) and/or a server computing device (e.g., cloud computing). For example, the collection of audio data and pre-processing of the audio data may be performed by an end-user computing device and other operations may be performed by a server.

Computing device 500 may include any components typical of a computing device, such as volatile or nonvolatile memory 520, one or more processors 521, and one or more network interfaces 522. Computing device 500 may also include any input and output components, such as displays, keyboards, and touch screens. Computing device 500 may also include a variety of components or modules providing specific functionality, and these components or modules may be implemented in software, hardware, or a combination thereof. Below, several examples of components are described for one example implementation, and other implementations may include additional components or exclude some of the components described below.

Computing device 500 may have a signal processing component 530 for performing any needed operations on an input signal, such as analog-to-digital conversion, encoding, decoding, subsampling, or windowing. Computing device 500 may have a feature extraction component 531 that computes feature vectors from audio data or an audio signal. Computing device 500 may have a model selector component 532 that receives an asserted identity and retrieves a corresponding speaker verification model from a data store, such as verification models data store 131. Computing device 500 may have a model processing component 533 that receives feature vectors and a model (such as a speaker verification model, a UBM, or a cohort model) and generates a score indicating a match or similarity between the feature vectors and the model. Computing device 500 may have a score processing component 534 that determines whether a user corresponds to an asserted identity using scores generated by model processing component 533. Computing device 500 may have a G2P conversion component 535 that receives a prompt and generates a linguistic representation of the prompt. Computing device 500 may have a UBM builder component 536 that generates a UBM from a sequence of speech units and acoustic models for the speech units, such as acoustic models retrieved from acoustic models data store 230. Computing device 500 may have a model adaptation component 537 that adapts an existing model (such as a UBM) using other data, such as enrollment data or cohort data, to generate an adapted model.

Computing device 500 may have or may have access to a data store of verification models 131 to be used in performing classification. Computing device 500 may have or may have access to a data store of acoustic models 230 to be used in building a UBM.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network. A computer program may reside in volatile memory, non-volatile memory, RAM, flash memory, ROM, EPROM, or any other form of a non-transitory computer-readable storage medium.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can be implemented in combination in a single implementation. Conversely, various features that are described in the context of a single implementation can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a prompt for use with a text-dependent speaker verification system;
generating a linguistic representation of the prompt, wherein the linguistic representation comprises a sequence of speech units;
obtaining, from a data store of feature vectors, a plurality of feature vectors for each speech unit in the plurality of speech units;
generating a universal background model for the prompt using the plurality of feature vectors for each speech unit in the plurality of speech units;
receiving audio enrollment data of a first user speaking the prompt; and
creating a first speaker verification model for the prompt and the first user by adapting the universal background model for the prompt using the audio enrollment data.

2. The method of claim 1, further comprising:
receiving audio data for speaker verification processing, wherein the audio data represents speech of a user;
processing the audio data with the first speaker verification model to generate a first score;
processing the audio data with the universal background model to generate a second score; and
determining that the user is the first user using the first score and the second score.

3. The method of claim 2, wherein the audio data comprises feature vectors extracted from an audio signal.

4. The method of claim 1, further comprising:
generating a plurality of cohort models for the prompt, wherein each cohort model is generated by:
obtaining audio data for a respective cohort; and
adapting the universal background model using the audio data for the respective cohort.

5. The method of claim 4, further comprising:
receiving audio data for speaker verification processing, wherein the audio data represents speech of a user;
processing the audio data with the first speaker verification model to generate a first score; and
processing the audio data with the plurality of cohort models to generate a plurality of scores; and
determining that the user is the first user using the first score and the plurality of scores.

6. The method of claim 5, wherein determining that the user is the first user using the first score and the plurality of scores comprises:
generating a normalized first score using the first score and the plurality of scores; and
comparing the normalized first score to a threshold.

7. The method of claim 6, wherein generating the normalized first score comprises:
calculating a mean of the plurality of scores;
calculating a standard deviation of the plurality of scores;
subtracting the first score by the mean; and
dividing a result of the subtracting by the standard deviation.

8. The method of claim 6, wherein generating the normalized first score comprises using a Z-norming procedure, a T-norming procedure, a ZT-norming procedure, or an S-norming procedure.

9. The method of claim 1, wherein the speech units comprise phonemes, phonemes in context, portions of phonemes, combinations of phonemes, triphones, syllables, portions of syllables, or combinations of syllables.

10. The method of claim 1, wherein adapting the universal background model comprises performing maximum a posteriori adaptation or maximum likelihood linear regression adaptation.

11. The method of claim 1, wherein generating the universal background model for the prompt using the plurality of feature vectors for each speech unit in the plurality of speech units comprises generating a Gaussian mixture model for the universal background model using the expectation-maximization algorithm.

12. The method of claim 1, wherein generating the universal background model for the prompt using the plurality of feature vectors for each speech unit in the plurality of speech units comprises weighting a first feature vector corresponding to a first speech unit, wherein a weight of the first feature vector is determined using at least one of (i) an expected duration of the first speech unit, (ii) a number of occurrences of the first speech unit in the prompt, or (iii) a number of feature vectors corresponding to the first speech unit.

13. A system for performing speaker verification, the system comprising one or more computing devices comprising at least one processor and at least one memory, the one or more computing devices configured to:
receive a prompt for use with a text-dependent speaker verification system;
generate a linguistic representation of the prompt, wherein the linguistic representation comprises a sequence of speech units;
obtain, from a data store of feature vectors, a plurality of feature vectors for each speech unit in the plurality of speech units;
generate a universal background model for the prompt using the plurality of feature vectors for each speech unit in the plurality of speech units;
receive audio enrollment data for a first user;
create a first speaker verification model for the prompt and the first user by adapting the universal background model for the prompt using the audio enrollment data;
receive audio data for speaker verification processing, wherein the audio data represents speech of a user;
process the audio data with the first speaker verification model to generate a first score;
process the audio data with a second model to generate a second score; and
determine that the user is the first user using the first score and the second score.

14. The system of claim 13, wherein the one or more computing devices are further configured to:
receive an asserted identity of the user;
retrieve the first speaker verification model from a data store using the received asserted identity.

15. The system of claim 13, wherein the prompt comprises one or more words and wherein the prompt is received from the first user.

16. The system of claim 13, wherein the one or more computing devices are further configured to generate the universal background model for the prompt using the plurality of feature vectors for each speech unit in the plurality of speech units by weighting a first feature vector corresponding to a first speech unit, wherein a weight of the first feature vector is determined using at least one of (i) an expected duration of the first speech unit, (ii) a number of occurrences of the first speech unit in the prompt, or (iii) a number of feature vectors corresponding to the first speech unit.

17. One or more non-transitory computer-readable media comprising computer executable instructions that, when executed, cause at least one processor to perform actions comprising:
receiving a prompt for use with a text-dependent speaker verification system;
generating a linguistic representation of the prompt, wherein the linguistic representation comprises a sequence of speech units;
obtaining a plurality of acoustic models, wherein each acoustic model in the plurality of acoustic models (i) corresponds to a speech unit in the sequence of speech units and (ii) describes a pronunciation of the speech unit for a plurality of speakers;
generating a universal background model for the prompt by combining the plurality of acoustic models;
receiving audio enrollment data of a first user; and
creating a first speaker verification model for the prompt and the first user by adapting the universal background model for the prompt using the audio enrollment data.

18. The one or more non-transitory computer-readable media of claim 17, the actions further comprising:
generating a plurality of cohort models for the prompt, wherein each cohort model is generated by:
obtaining audio data for a respective cohort; and
adapting the universal background model using the audio data for the respective cohort.

19. The one or more non-transitory computer-readable media of claim 17, wherein generating the linguistic representation of the prompt comprises obtaining a sequence of speech units from a previously-generated lexicon.

20. The one or more non-transitory computer-readable media of claim 17, wherein the audio enrollment data represents speech of the first user speaking the prompt.

21. The one or more non-transitory computer-readable media of claim 17, wherein the plurality of acoustic models comprises Gaussian mixture models, hidden Markov models, or neural network models.

22. The one or more non-transitory computer-readable media of claim 17, wherein combining the plurality of acoustic models comprises combining Gaussian mixture models, wherein a weight of the combined Gaussian mixture model is determined using at least one of (i) an expected duration of a speech unit or (ii) a number of occurrences of a speech unit in the prompt.
